(19) United States
(12) Patent Application Publication
(10) Pub. No.: US 2006/0061851 A1
(43) Pub. Date: Mar. 23, 2006

(54) Structure for facilitating high precision focusing of laser for scanner and the like

(76) Inventors: Toru Takahashi, Saitama Pref. (JP); Masayoshi Yamanouchi, Saitama Pref. (JP)

Correspondence Address: KAPLAN GILMAN GIBSON & DERNIER L.L.P., 900 ROUTE 9 NORTH, WOODBRIDGE, NJ, 07095, US

(21) Appl. No.: 10/948,109

(22) Filed: Sep. 23, 2004

(51) Int. Cl. G02B 26/02

(52) U.S. Cl. 359/232; 359/227

(57) ABSTRACT

An improved technique of adjusting the focal point of a laser diode within an optical tube in disclosed. The beamwidth of the emitted laser is kept relatively wide during the adjustment process, and is narrowed thereafter and in operation of the device. A technique of narrowing the beam includes utilizing an insert with a slit that is installed after the adjustment of the focal point.

### TECHNICAL FIELD

This invention relates to laser diodes such as those used in scanners for reading bar codes and other symbols.

### BACKGROUND OF THE INVENTION

Laser scanners are widely used to read barcodes and other symbols. Such scanners typically scan across one or more lines and read a sequence of dark and light areas in which information of interest in encoded. In such systems, it is important that that laser be focused correctly at an appropriate focal point.

A typical prior art arrangement for such optical scanners is shown in FIG. 1. The arrangement includes a laser diode 102 installed within an optical tube 101, at a prescribed distance 105 from the lens 103. Importantly, the distance 105 from the lens at which the laser diode 102 is installed is the critical parameter that determines the focal point. Therefore, the laser diode 102 of FIG. 1 is often installed in cooperative arrangement with an adjustment screw. The adjustment screw can be used to slightly change the distance 105 between the lens 103 and the laser diode 102 thereby adjusting the focal point.

One problem with such prior art arrangements is that the laser output during operation must have a relatively small diameter, for example, approximately 1-1.1 millimeters. The change in focal point that results from a specified change in the distance 105 is dependant to a large extent upon the diameter of the laser beam. More specifically, it is difficult in prior systems to obtain a precise adjustment of the focal point because even the slightest change in the distance 105 causes a relatively major change in the focal the focal point. This is due largely to the fact that the beam width required in operation is so small.

It is an object of the invention to provide a method and apparatus for facilitating a more accurate adjustment of the distance 105 and the focal point of the resulting laser beam, even in systems where the required beam width is very small.

### BRIEF DESCRIPTION OF THE DRAWINGS

FIG. 1 depicts a prior art optical tube with a laser diode and lens installed;

FIG. 2 depicts a partially assembled optical tube with laser diode in accordance with the present invention; and

FIG. 3 shows a more fully assembled optical tube with other components in accordance with the present invention.

### DETAILED DESCRIPTION OF THE PREFERRED EMBODIMENT

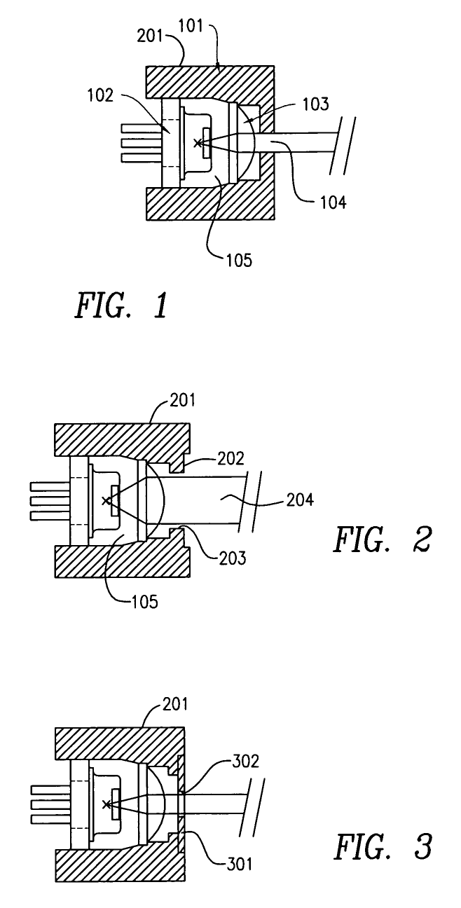

FIG. 2 shows an exemplary embodiment of the present invention that includes an optical tube 201. The optical tube 201 includes a relatively large opening 203, likely unsuitable for use during scanning operation. The beam 204 as shown has a much larger diameter than the beam 104 shown in FIG. 1.

Although the beam 204 is too large to be used for practical scanning, the relatively large diameter results in a smaller change in the focal point for a specified change in the distance 105. Put another way, the same error in distance 105 will translate into a smaller change in the focal point in the arrangement of FIG. 2 then in the case of the arrangement of FIG. 1. So, by keeping the beam width relatively wide during adjustment, the adjustment process is made significantly easier.

FIG. 3 shows the assembly after adjustment and when the beam width must be made smaller for use in an actual laser scanner. A small insert 301 is utilized, having a slit 302, which blocks out the outer portions of the beams so that the diameter is as small as it should be. In a practical example, good performance was achieved with a system wherein without the insert 301, the beam diameter immediately after exiting the apparatus was approximately 2.8 millimeters, and the beam diameter at the same point with the slit installed was about 1.45 millimeters. So, the diameter of the beam that would actually be used may be increased by almost a factor of two, for the purpose of adjusting the focal point.

The insert may be attached after adjustment in any convenient manner. One such manner would be to simply snap fit it to the front portion of the optical tube 201. Another possibility would be to use glue to attach the insert 301 around the back outer portion thereof to the surface formed at 202. The particular technique utilized to attach the insert 301 is not critical to the present invention.

While the above describes the preferred embodiment, it is apparent that other techniques of utilizing a wide beam width of focal point adjustment, and a narrow beam width during operation only will be apparent to those of skill in the art. One such method would be to have the opening adjustable, using a larger setting when adjusting the focal point, and a smaller one when actually using the device to read symbols. Other variations of the invention are possible as well. Such methods are intended to be covered by the claims appended hereto.

1. A method of adjusting and then using laser within an optical tube, the method comprising the steps of setting a beam width of a beam emitted by said laser to a first value during said adjustment, setting said beam width to a second value after said adjustment and prior to use, said first value being greater than said second value.

2. The method of claim 1 wherein said laser is used in an optical scanner.

3. The method of claim 2 wherein said beam width is set to said second value by placing and insert with a slit over an end of an optical tube.

4. The method of claim 3 wherein said slit decreases said beam width by an amount between 25 and 75 percent.

5. The method of claim 3 wherein said insert is attached by means of glue.

6. The method of claim 3 wherein said slit is snap fit to said optical tube.

7. Apparatus for use in a laser scanner comprising an optical tube have a laser diode therein and a lens, and an opening at an end of said optical tube out of which a beam from said laser diode emanates after passing through a lens, said opening having an adjustable width, said width being adjustable to change its area from a first value during adjustment to a second value.

8. The apparatus of claim 7 wherein said opening is substantially circular prior to said adjustment.

9. The apparatus of claim 8 wherein said opening includes an attachment means to secure and insert thereto so that said opening may be reduced in area.

10. The apparatus of claim 9 wherein said insert contains a slit.

11. The apparatus of claim 10 wherein said second value is slightly more than half said first value.
